(19) United States
(12) Patent Application Publication
(10) Pub. No.: US 2007/0269282 A1
(43) Pub. Date: Nov. 22, 2007

(54) System and method of boring a pre-formed guide in a single pass

(76) Inventors: John S. Agapiou, Rochester Hills, MI (US); Brian F. Hacker, Williamston, MI (US); Antoni E. Kozicki, St. Catharines (CA)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 11/436,312

(22) Filed: May 18, 2006

(51) Int. Cl. B23Q 1/28; B23P 23/00

(52) U.S. Cl. 409/64; 29/56.5; 29/564

(57) ABSTRACT

A system and method for machining a workpiece in a single-pass comprising a guide formation mechanism configured to produce a guide element, a combination tool configured to concurrently produce a pilot and finish borehole, and a tool holder for securing and rotating the tool, wherein the guide presents first and second hole sections having differing diameters, and the tool presents first and second cutting tool sections having differing diameters, and said first and second hole and tool sections are cooperatively configured.

### BACKGROUND OF THE INVENTION

1. Technical Field

The present invention relates to apparatuses, systems, and methods for reaming or otherwise producing a hole within a workpiece, and more particularly, to a system and method for manufacturing a production quality hole within the workpiece in a single pass, wherein said system includes a mechanism for producing a pre-formed guide, and a combination cutting tool.

2. Background Art

In the automotive industry, methods of manufacturing cylinder heads play important roles in determining the overall cost of producing an internal combustion engine. The heads perform the important primary function of providing passageways for sufficient fuel and air to enter into a plurality of combustion chambers cooperatively defined by the heads, pistons, and cylinders of the engine. As such, each head typically presents an integrated body that defines a plurality of passageways (or holes). Each passageway is specifically configured to house a valve stem, so as to cyclically control the ingress and egress of fuel, air and exhaust. More particularly, these passageways include valve-guides and valve seats, wherein the oscillating valve stems are caused to translate.

Conventional processes have been developed for efficiently producing finished valve guides, and meeting the tolerances necessary to achieve desired performance. On a mass scale, these processes typically include automated three-dimensional work cells and robotic operation for manipulating rough dies (or workpieces) produced from raw material, such as aluminum or steel. Automated sub-routines are provided for performing various cutting and boring functions necessary to produce the finished valve guide boreholes in the workpiece within specified controls (e.g., 60.010 mm, perfect straightness, and maximum runout of 0.080 mm to the seat, etc.). These sub-routines typically employ a Computer Numerical Control (CNC) machine to provide a precision cutting, programmable and flexible machining process. The CNC machine is typically used in conjunction with standard reamer tools to finish the valve guides, which are typically pre-formed by a powder metallurgy process and pressed into the workpiece.

The sub-routines and processes used for machining the finished valve guides, however, present various cost inefficiencies and concerns. In order to produce a production quality hole, a plurality of passes, including a first pass wherein a smaller diameter tool is used to create a pilot (or starter) bore through a fraction of the workpiece depth, and a second finishing pass wherein the finishing tool is used to produce the final bore through the full workpiece depth, must be utilized to avoid unacceptable eccentricities caused by tool deflection. Though, the pilot bore minimizes deflection during the finishing application, its implementation adds to the overall production time, and labor/energy costs. The addition of a second tool and accompanying redundant mechanisms result in a reduction of available workspace, a more complex process, and the need for greater repair and inventory capacity.

Conventional squirt-reamer single-pass processes have been developed to address these concerns. But they themselves present various configuration and efficiency concerns that make them unsuitable for CNC machining processes. More particularly, these conventional single-pass systems are typically used with transfer line equipment or equipment dedicated to a single or limited number of uses, and incorporate a dedicated fourth axis concentrically aligned with the spindle to pilot the tool through a bushing positioned at the entrance of the bore. The bushing is fixedly secured relative to the spindle and tool holder, and configured to support the tool as it translates, so as to control its location, straightness, and runout relative to the valve-seat.

These squirt-reaming systems, however, cannot be used with CNC machines due to the required flexibility with the tool change system. Conventional CNC machines are not configured to perform the necessary tool translations relative to the machining apparatus. It is readily apparent that substantial modifications to existing CNC machines would be required to enable tool translation, in this manner. Finally, it is also appreciated that incorporating the complex mechanical designs of conventional squirt reaming systems in a CNC machining process would result in higher susceptibility to failures, more maintenance for the station, and lower productivity.

Thus, there is a need in the art for a single-pass finished bore machining system, and an improved process for producing cylinder heads having finished valve-guides, that is less complex, and thereby more cost efficient.

### SUMMARY OF THE INVENTION

Responsive to these and other concerns caused by conventional machining processes, the present invention concerns an system and method of manufacturing/machining a finished hole in a single pass. The inventive process is useful, among other things, for producing a production quality hole in a single pass, and thereby, eliminating costs associated with multiple passes.

A first aspect of the present invention concerns a system for machining a finished bore in a single pass. The system includes a guide formation mechanism configured to produce a tubular element, wherein the element defines a longitudinal pre-formed opening. The system further includes a tool presenting a distal end, when inserted into a tool holder. The tool is configured to contact and produce the finished bore within the element, when rotated and translated relative to the element. Finally, the tool holder is configured to secure the tool in a fixed position relative to the tool holder, and rotate the tool. The mechanism is further configured so that the hole presents first and second adjacent hole sections having differing first and second average hole diameters. The tool presents a first cutting tool section having a first operating tool diameter, adjacent the distal end, and a second cutting tool section having a larger operating diameter than the first operating diameter, adjacent the first tool section.

A second aspect of the present invention concerns a method of producing the finished bore in a single-pass within the workpiece. Further disclosure is made as to preferred and exemplary embodiments of the invention. These and other features of the present invention are discussed in greater detail in the section below entitled DESCRIPTION OF THE PREFERRED EMBODIMENT(S).

### BRIEF DESCRIPTION OF THE DRAWINGS

Preferred embodiments of the invention are described in detail below with reference to the attached drawing figures, wherein:

FIG. 1 is a perspective view of an integrated cylinder head or workpiece and plurality of valve guides or elements, in accordance with a preferred embodiment of the present invention;

FIG. 2 is an enlarged perspective view of a two-step valve guide element in accordance with a preferred embodiment of the present invention;

FIG. 2a is a cross-sectional view of the element shown in FIG. 2;

FIG. 2b is a cross-sectional view of a valve guide or element in accordance with a preferred embodiment of the present invention, wherein the guide defines a hole having a polygonal cross-section.

FIG. 3 is an elevation view of a guide formation mechanism configured to produce a rough pre-formed valve guide or element, particularly illustrating two forms and an insertable two-step pin;

FIG. 3a is a plan view of the mechanism shown in FIG. 3, particularly showing the forms in a disengaged position, and in an engaged position by hidden line;

FIG. 4 is an elevation and partially cross-sectional view of the guide, workpiece, tool, and tool holder, in accordance with a preferred embodiment of the present invention, wherein said tool and guide present a disengaged condition;

FIG. 4a is an elevation view of a guide, in accordance with a second preferred embodiment of the present invention, wherein the guide presents a straight wall opening;

FIG. 4b is an elevation view of a guide, in accordance with a third preferred embodiment of the present invention, wherein the guide presents a tapered wall opening;

FIG. 5 is an elevation and partially cross-sectional view of the guide and tool shown in FIG. 4 in a dual engaged condition, wherein both the first and second tool sections engage the guide; and

FIG. 6 is an elevation and partially cross-sectional view of the guide and tool shown in FIGS. 4 and 5, in a ream engaged condition, wherein only the second tool section engages the guide.

### DETAILED DESCRIPTION OF THE PREFERRED EMBODIMENT(S)

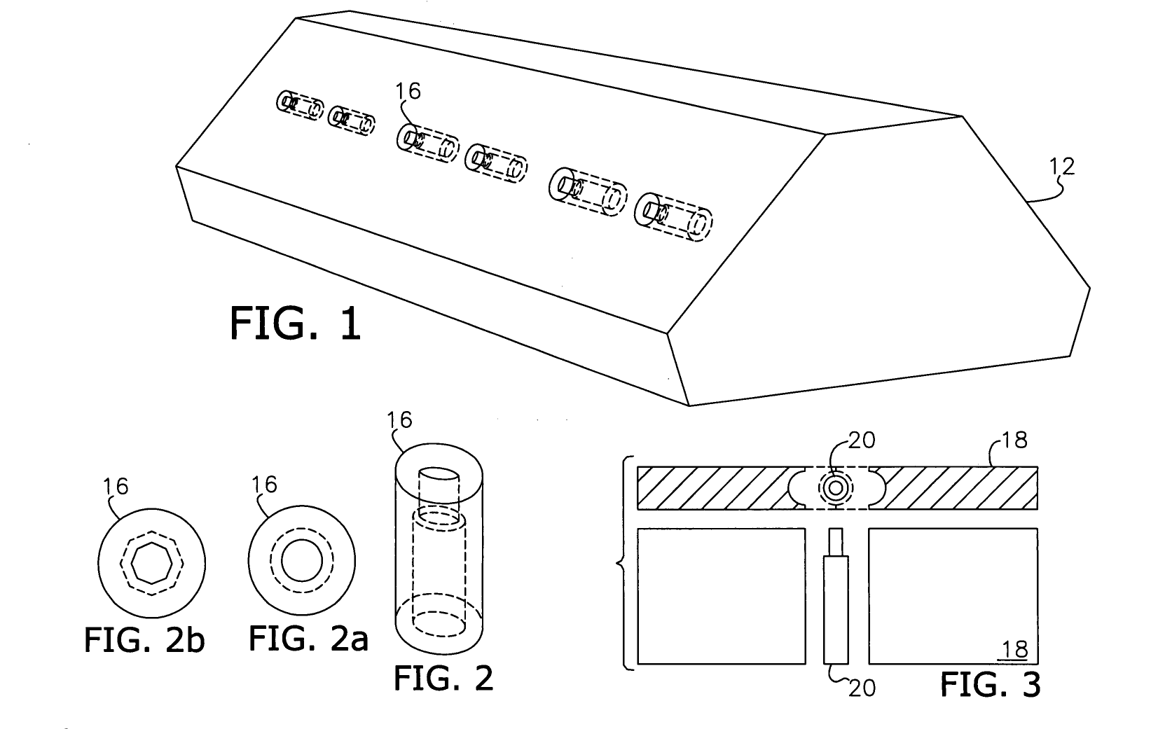

As illustrated and described herein, the present invention relates to a system 10 for and method of manufacturing/machining the finished valve-guides of a cylinder head or workpiece 12 (see, FIG. 1) in a single pass. In automotive manufacture, valve-guides and seats are typically produced as part of the porting process, wherein the passageways of the engine cylinder heads are created. In this process, production of the valve-guides and seats involves a multi-step process, wherein a separately produced valve guide is integrated with the cylinder head 12, initially pilot bored, and then enlarged and finished to specifications. The present invention presents a single-pass method of performing the pilot and finishing steps. As previously mentioned, it is appreciated by those ordinarily skilled in the art that the inventive system 10 improves upon conventional methods and systems by eliminating a second-pass during the boring process, and the costs associated therewith. Though described and illustrated herein with respect to the automotive manufacturing process, it is also appreciated that the system 10 and method of the present invention may be utilized in any machining process where it is desirous to combine multi-passes into a single-pass to produce a finished borehole.

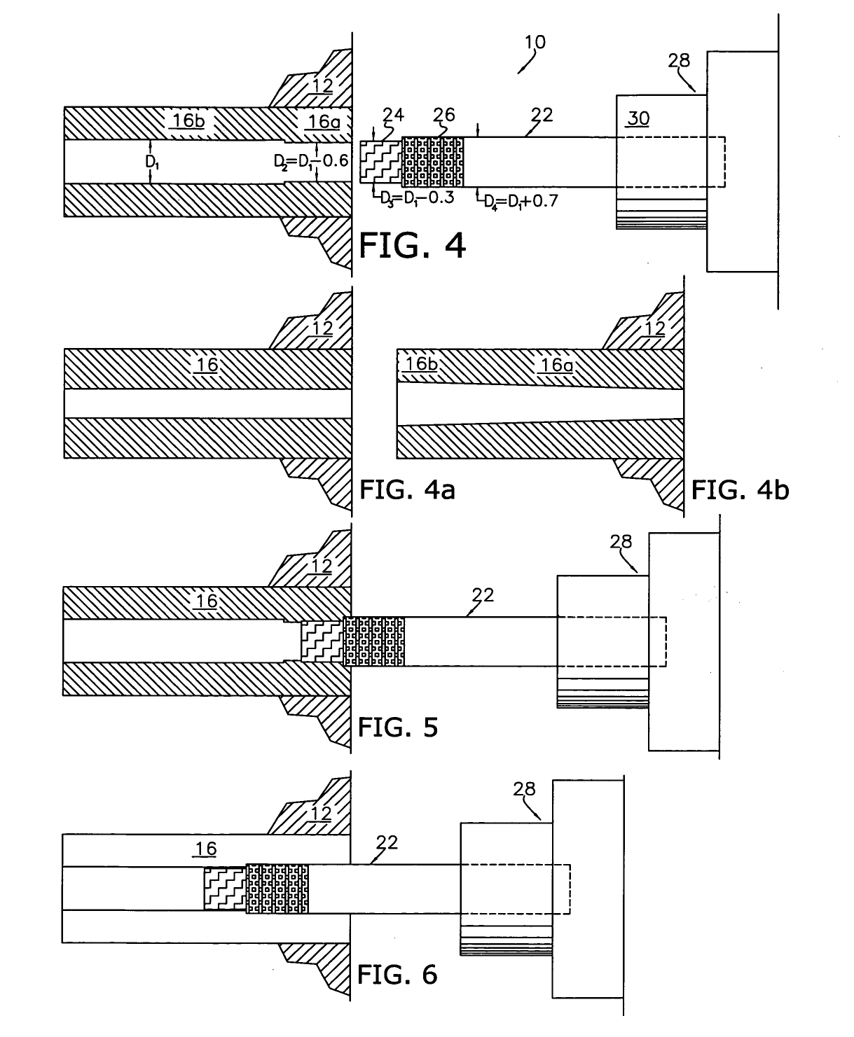

The system 10 includes a guide formation mechanism 14 configured to produce an innovative valve-guide or element 16 (see, FIG. 2). As shown in FIG. 3, the preferred formation mechanism 14 is configured to produce a tubular guide 16 utilizing a powder metallurgy process wherein forms 18 and a pin 20 are cooperatively configured to receive a dry powder or pellets in an engaged position (shown by hidden line in FIG. 3) and produce a cast when heat and/or pressure is applied to the powder or pellets. As shown in FIGS. 4, 4a, and 4b, the guide 16 may be formed, so as to defined a straight wall, tapered, or, more preferably, a multi (e.g. two)-step opening.

Alternatively, the guide 16 may be formed by rough boring a solid cylindrical die, wherein a first bore presents a first diameter and extends through a portion of the longitudinal depth, and a second concentric bore extends through the full depth. It is appreciated that separately forming the cylinder heads 12 and guides 16 enables a more cost effective integrated unit to be produced, while providing the added structural and resistance capacity at the fuel/air interface. For example, the cylinder heads 12 may be formed from raw aluminum castings or aluminum alloy, while the guides 16 may consist of a harder and more corrosion resistive metal, such as steel.

As previously mentioned, the mechanism 14 is preferably configured to produce a guide 16 that defines a two-step opening, and includes a two-step pin 20 to that end. As shown in FIG. 2, the concentrically aligned opening longitudinally extends along the full depth of the guide 16, so that the guide 16 presents two adjacent sections 16a,b having differing inside diameters, and circular cross-sections (see FIG. 2a). In an alternative embodiment shown in FIG. 2b, the guide 16 may define an opening having a polygonal cross-section, in which case the term “diameter” shall mean the average diameter of the cross-section, unless otherwise specified. The guide 16 and workpiece 12 are oriented during integration, so that the section defining the smaller inside diameter is further from the interior or more specifically, center of gravity of the workpiece 12 (see, FIG. 1). Thus, as shown in FIGS. 4 through 6, section 16a of the guide 16 is radially exterior to section 16b, and presents the first hole section as described herein.

The system 10 further includes a combination cutting tool 22 adapted for use with a conventional milling, transfer line, or CNC machine, such as manual, 2-axis, and 3-axis vertical machining centers, and their equivalents. The tool 22 generally presents a multi-step milling and/or reaming bit. In the illustrated embodiment shown in FIGS. 4 through 6, the tool 22 presents a two-step bit having first and second sections 24,26 of differing diameters. The first section 24 is preferably adjacent the distal end of the tool 22, when secured by a tool holder 28, and presents a smaller cross-sectional diameter than the remaining bit diameter. Alternatively, the first tool section 24 may be spaced from the end by a non-cutting section, such as a guide hole probe (not shown). As typical, the tool holder 28 more particularly includes a spindle 30, and drive means (also not shown) for rotating the spindle 30. The first tool section 24 preferably presents a milling section configured to cut or shave the guide 16 along at least a fraction of the pre-formed opening depth in both the radial and longitudinal directions, and may present any suitable configuration or length. For example, the first section 24 may present a ball end, ¼-rounding, 2-flute, 3-flute, 4-flute, 5-flute, or a 6-flute section, depending upon the intended application.

The preferred second tool section 26 is located generally adjacent the first tool section 24, and is configured to ream the pre-formed opening and/or previously milled pilot borehole of the guide 16. More preferably, the second tool section 26 further presents a longitudinal cutting surface 26a along the longitudinally perpendicular step to enable further milling of the guide 16. The boreholes formed by the first and second tool sections 24,26 define their respective operating diameters (typically defined by the maximum width of the tool or flutes along the tool section).

More preferably, the guide hole sections 16a,b and tool sections 24,26 are cooperatively configured so that the first tool section 24 presents an operating diameter larger than the diameter of the first hole section 16a, and smaller than the diameter of the second hole section 16b. The second tool section 26 presents an operating diameter that is larger than the diameter of the second section 16b, so as to ream the pre-formed opening and pilot borehole. Finally, so as to initially provide concurrent tool section engagement with the guide 16, the length of the first hole section is greater than the length of the first tool section 24. It is appreciated that such dual engagement further limits deflection during the critical initial stages of the boring process, and that disengagement by the first tool section 24 with the larger second hole section 16b increases the life of the first tool section 24.

Where polygonal cross-sections are defined by the guide 16, the first tool section 24 presents an operating diameter larger than the maximum inside diameter of the first hole section 16a, and smaller than the minimum diameter of the second hole section 16b, and the second tool section 26 presents an operating diameter larger than the maximum diameter of the second hole section 16b. Similarly, where tapered wall openings are defined, the hole and tool sections are likewise configured.

In the illustrated embodiment shown in FIG. 4, where the second hole section 16b of the guide 16 presents a diameter, D₁, the first hole section 16a presents a diameter, D₂, that is 0.6 mm to 1.3 mm less than D₁, the first tool section 24 presents a diameter, D₃, that is 0.3 to 0.7 mm less than D₁, and the second tool section 26 presents a diameter, D₄, equal to D₁ plus 0.7 mm. Where the first hole section 16a of the guide 16 presents a length, L₁, the first tool section 24 presents a length, L₂, that is at least 0.3 mm less than L₁. For example, the first tool section may present an operating diameter of 5.0 mm, while the second hole section presents an average diameter of 5.3 mm, the second tool section presents an operating diameter of 6.0 mm, and the first hole section presents an average diameter of 4.7 mm. The relationship between the diameters could vary but D₁ is greater than D₂ and D₃ is smaller than D₄. In addition, D₃ is larger than D₂ and D₄ is greater than D₁. In addition, D₃ is smaller than D₁ so that the diameter D₃ does not touch the wall of D₁ while D₄ is cutting and generating the finish size for the guide bore. The difference (D₁−D₃) is affected by the manufacturing capability of pressing the guide as closed to the theoretical position as possible by the previous operations. The mis-location between the guide and the spindle position to finish the bore is absorbed by the clearance (D₁−D₃) so that the front of the tool never touches the wall of D₁. In general, D₁−0.3≧D₃≧D₂+0.3 and D₄≧D₁+0.6.

Thus, as shown in FIGS. 4 through 6, to perform the single-pass finished bore process of the present invention, the preferred tool 22 and guide 16 are initially positioned and oriented, so as to achieve a pre-engaged condition wherein the first and second hole and tool sections are concentrically aligned (see, FIG. 4). Upon manual or robotic actuation by a user, the rotating tool 22 is linearly translated along the longitudinal axis relative to the guide 16, so as to engage and shave or cut material from the guide 16. As shown in FIG. 5, once the first tool section 24 is fully inserted into the guide 16, the tool 22 and guide 16 achieve a dual engaged condition wherein the first and second tool sections are engaged with and shaving or cutting the guide 16. The length of the first hole section 16a is configured so that the dual engaged condition duration is sufficient to minimize tool deflection to within tolerable levels. Finally, where differing hole section diameters are presented, and the first tool section 24 clears the first hole section 16a, the tool 22 and guide achieve a ream engaged condition, where only the second tool section 26 engages the guide 16 (see, FIG. 6).

The tool 22 continuously translates and reams through the full depth of the guide 16 to produce the finished bore, and is subsequently withdrawn. More preferably, the tool 22 additionally reams the borehole in a reverse process during withdrawal, so as to further refine the finished bore. The bore hole presents the design diameter within tolerances.

The preferred forms of the invention described above are to be used as illustration only, and should not be utilized in a limiting sense in interpreting the scope of the present invention. Obvious modifications to the exemplary embodiments and methods of operation, as set forth herein, could be readily made by those skilled in the art without departing from the spirit of the present invention. The inventors hereby state their intent to rely on the Doctrine of Equivalents to determine and assess the reasonably fair scope of the present invention as pertains to any system or method not materially departing from but outside the literal scope of the invention as set forth in the following claims.

What is claimed is:

1. A system for machining a finished borehole in a single pass, said system comprising:
a guide formation mechanism configured to produce a tubular element, wherein the element defines a longitudinal pre-formed opening;
a tool configured to ream the element to produce the finished borehole within the element, when rotated and translated relative thereto; and
a tool holder configured to rotate the tool and secure the tool in a fixed position relative to the tool holder, so as to present a distal tool end,
said tool presenting a first cutting tool section having a first operating tool diameter, adjacent the distal tool end, and a second cutting tool section having a second operating tool diameter larger than the first operating diameter, adjacent the first tool section.

2. The system as claimed in claim 1,
said element presenting first and second adjacent hole sections having differing inside diameters, so as to define a two-step opening.

3. The system as claimed in claim 2,
said first tool section having an operating diameter larger than the maximum inside diameter of the first hole section, and smaller than the minimum diameter of the second hole section.

4. The system as claimed in claim 3,
said first tool section having an operating diameter 0.3 to 0.7 mm larger than the maximum inside diameter of the first hole section, and 0.3 to 0.7 mm smaller than the minimum inside diameter of the second hole section.

5. The system as claimed in claim 3,
said second tool section having an operating diameter larger than the maximum inside diameter of the second hole section.

6. The system as claimed in claim 5,
said second tool section having an operating diameter 0.7 to 1 mm larger than the maximum inside diameter of the second hole section.

7. The system as claimed in claim 3,
said first hole section having a longitudinal length, L,
said first tool section having a longitudinal length at least 3.0 mm shorter than L.

8. The system as claimed in claim 1,
said first and second tool sections being configured to concurrently shave material from the element, so as to mill or ream the element to produce pilot and finished boreholes, during the pass.

9. The system as claimed in claim 1,
said element defining an opening having a polygonal cross-section.

10. The system as claimed in claim 1,
said element defining an opening having tapered walls.

11. The system as claimed in claim 1,
said opening and first and second tool sections presenting concentrically alignable longitudinal axis.

12. A system for machining a finished borehole in a single pass, said system comprising:
a guide formation mechanism configured to produce a tubular element, wherein the element defines a longitudinal opening;
a tool configured to ream the element to produce the finished borehole within the element, when rotated and translated relative thereto; and
a tool holder configured to rotate the tool and secure the tool in a fixed position relative to the tool holder, so as to present a distal tool end,
said tool presenting a first cutting tool section having a first operating tool diameter, adjacent the distal tool end, and a second cutting tool section having a second operating tool diameter larger than the first operating diameter, adjacent the first tool section,
said element presenting first and second adjacent hole sections having differing first and second inside diameters respectively,
said first tool section having an operating diameter larger than the diameter of the first hole section, and smaller than the diameter of the second hole section,
said second tool section having an operating diameter larger than the diameter of the second hole section,
said first hole section having a longitudinal length, L,
said first tool section having a longitudinal length shorter than L.

13. A method of producing a finished borehole within an element, in a single machining pass, said method comprising the steps of:
a) producing the element, wherein said element presents a longitudinally oriented two-step opening, and includes a first hole section presenting a first inside diameter and a second hole section presenting a second inside diameter that is larger than the first diameter;
b) milling or reaming the element along the first hole section during multiple occurrences, so as to produce a pilot borehole and a finished borehole within the first hole section, during the pass; and
c) milling or reaming the element along the second hole section, so as to produce a finished borehole within the second hole section, during the pass.

14. The method as claimed in claim 13,
steps b) further including the steps of rotating and translating a plurality of cutting surfaces, so that the first hole section is initially milled or reamed with a first cutting surface to produce the pilot borehole, and subsequently re-reamed with a second cutting surface to produce the finished borehole.

15. The method as claimed in claim 13,
step a) further including the steps of using a powder metallurgy process to produce the element, wherein said element presents a step hole having two different diameters.

16. A tool for performing the method claimed in claim 13, wherein said tool presents separate first and second curved cutting surfaces, the curvature of the first cutting surface is defined by a first radius, and the curvature of the second cutting surface is defined by a second radius that is larger than the first.

17. A tool for performing the method claimed in claim 16, wherein said tool presents separate first and second curved cutting surfaces, the curvature of the first cutting surface is defined by a first radius, and the curvature of the second cutting surface is defined by a second radius that is at least ten percent larger than the first.
